(19) United States
(12) Patent Application Publication
(10) Pub. No.: US 2017/0288994 A1
(43) Pub. Date: Oct. 5, 2017

(54) PACKET TRANSFER DEVICE AND METHOD FOR SETTING COUNTER

(71) Applicant: FUJITSU LIMITED, Kawasaki-shi (JP)

(72) Inventor: Masahiko MATSUURA, Kanazawa (JP)

(73) Assignee: FUJITSU LIMITED, Kawasaki-shi (JP)

(21) Appl. No.: 15/437,800

(22) Filed: Feb. 21, 2017

(30) Foreign Application Priority Data
Apr. 1, 2016 (JP) 2016-074486

(51) Int. Cl. H04L 12/26; H04L 12/815; H04L 12/833

(52) U.S. Cl. CPC H04L 43/08; H04L 47/31; H04L 47/22

(57) ABSTRACT

There is provided a packet transfer device including a memory, and a processor coupled to the memory and the processor configured to detect a first packet of a predetermined size, detect a second packet whose data in a predetermined area matches a specific pattern, the second packet being included in a group of the first packet, and count a number of the second packet.

### CROSS-REFERENCE TO RELATED APPLICATION

This application is based upon and claims the benefit of priority of the prior Japanese Patent Application No. 2016-074486, filed on Apr. 1, 2016, the entire contents of which are incorporated herein by reference.

### FIELD

The embodiments discussed herein are related to a packet transfer device, and a counter setting method.

### BACKGROUND

A multi-protocol label switching (MPLS) is known as a technique for transferring packets at a high speed. Since a packet transfer device using the MPLS transfers a packet by referring to a label attached to a packet, the packet may be transferred at a high speed.

This type of packet transfer device transfers not only an Ethernet® frame but also a circuit emulation service (CES) packet accommodating plural divided synchronous optical network (SONET)/synchronous digital hierarchy (SDH)/frames. In connection with the SONET/SDH, for example, Japanese Laid-Open Patent Publication No. 2014-179791 discloses a technique for detecting a missing frame length.

### SUMMARY

According to an aspect of the invention, a packet transfer device includes a memory, and a processor coupled to the memory and the processor configured to detect a first packet of a predetermined size, detect a second packet whose data in a predetermined area matches a specific pattern, the second packet being included in a group of the first packet, and count a number of the second packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an exemplary network system;

FIG. 2 is a view illustrating an example of a packet format;

FIG. 3 is a view illustrating an exemplary transfer of an Ethernet frame and a CES packet;

FIG. 4 is a view illustrating an exemplary transfer of a packet with a synchronization header;

FIG. 5 is a configuration diagram illustrating an example of a packet transfer device;

FIG. 6 is a configuration diagram illustrating an example of a port circuit;

FIG. 7 is a configuration diagram illustrating an example of a counter circuit;

FIG. 8 is a view illustrating the sizes of packets;

FIG. 9 is a configuration diagram illustrating an example of a first pattern detector and a second pattern detector;

FIG. 10 is a view illustrating a method of discriminating a CEP packet and a CES packet with a synchronization header;

FIG. 11 is a configuration diagram illustrating an example of a control card;

FIG. 12 is a view illustrating an example of a path database;

FIG. 13 is a view illustrating an example of a setting process of a counter circuit;

FIG. 14 is a configuration diagram illustrating an example of counter circuits for respective paths; and

FIG. 15 is a flowchart illustrating an example of a method for setting a counter circuit.

### DESCRIPTION OF EMBODIMENTS

A packet transfer device using MPLS transfers a packet by referring to a label attached to the packet. Therefore, when the packet is discarded by a band control, the type of the packet may not be specified. For this reason, for example, a network administrator may not perform appropriate band setting for the packet transfer device according to the amount of discard for each type of packet.

In order to specify the type of packet, in general, detailed analysis of the contents of a payload of the packet and the contents of various headers attached to the packet is performed. However, to this end, large-scale hardware is required.

Hereinafter, embodiments of a technique for counting packets of a specific type with a small-scale configuration will be described with reference to the drawings.

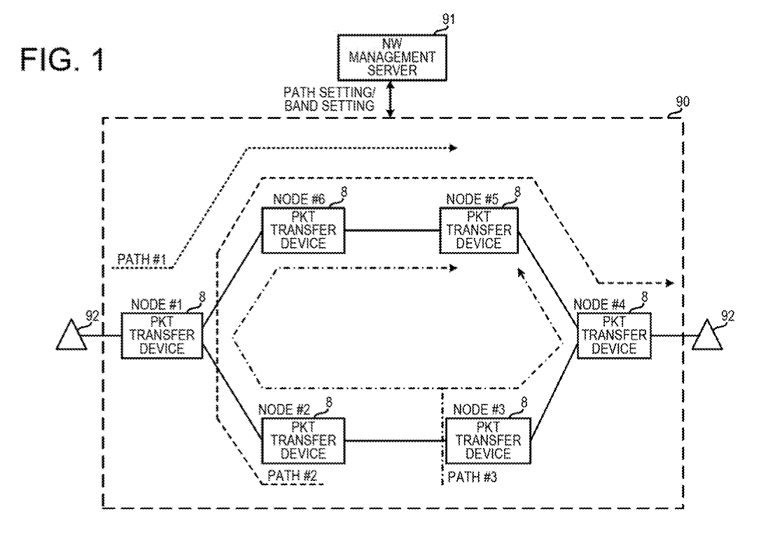

FIG. 1 is a configuration diagram illustrating an exemplary network system. As an example, the network system includes a network 90 to which nodes #1 to #6 are connected in a ring shape, a network management server (NW management server) 91 for monitoring and controlling the network 90, and a network device 92 for connecting with another network such as a router. The network 90 is not limited to the ring type one but may be, for example, a mesh type network.

A packet transfer device (PKT transfer device) 8 for transferring an input packet is provided for each of the nodes #1 to #6 in the network 90. Here, a packet transfer process is an example of a predetermined process performed by the packet transfer device 8. An example of the packet transfer device 8 may include, but is not limited to, a reconfigurable optical add and drop multiplexer (ROADM). As an example, based on the MPLS technology, the packet transfer device 8 transfers a packet to which a label indicating a transfer destination (hereinafter referred to as a “transfer label”) is added, based on the label.

For example, the network management server 91 sets, for example, paths #1 to #3 of a packet and a band of the packet for the packet transfer device 8 of each of the nodes #1 to #6. For example, the paths #1 to #3 are set so as to pass through a plurality of packet transfer devices 8 between network devices 92 which are respectively the start point and the end point. Although FIG. 1 illustrates that the network devices 92 are only connected to the respective packet transfer devices 8 of the nodes #1 and #4, the network devices 92 are also connected to the respective packet transfer devices 8 of the other nodes #2, #3, #5 and #6.

The path #1 passes through the packet transfer devices 8 of the nodes #1, #6, and #5 in this order. The path #2 passes through the packet transfer devices 8 of the nodes #2, #1, #6, #5, and #4 in this order.

The path #3 is redundantly configured and composed of two routes, one route passing through the packet transfer devices 8 of the nodes #3, #2, #1, #6, and #5 in this order and the other passing through the packet transfer devices 8 of the nodes #3, #4, and #5 in this order. The same packet is transferred to these two routes, and when a fault occurs, a hitless (uninterruptible) route switching is performed.

Various packets corresponding to communication services provided by the paths #1 to #3 are transferred to each of the paths #1 to #3.

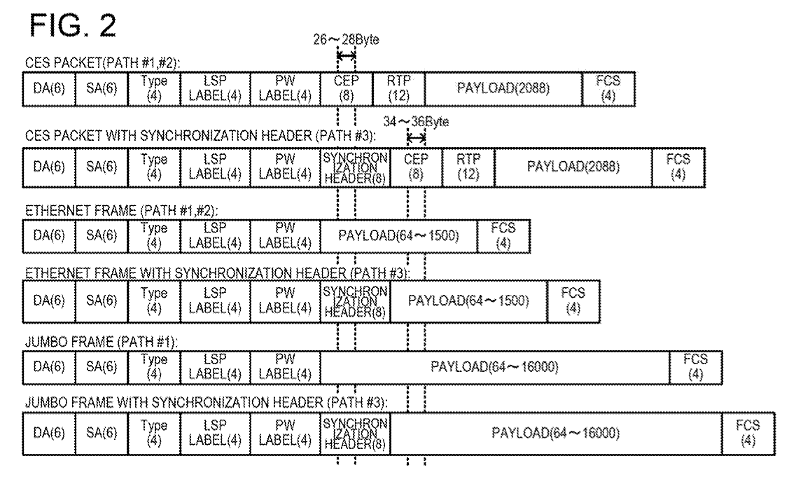

FIG. 2 illustrates an example of a packet format. Examples of packets transferred by a packet transfer device 8 may include a CES packet, a CES packet with a synchronization header, an Ethernet frame, an Ethernet frame with a synchronization header, a jumbo frame, and a jumbo frame with a synchronization header. The numerical values in parentheses described in plural areas of each packet indicate a data length (size in the unit of bytes) of the areas.

The CES packet is obtained by dividing data in a payload of a SONET/SDH frame and accommodating the divided data in a frame of the same format as the Ethernet frame. The CES packet includes a destination address (DA) which is a reception destination, a source address (SA) which is a transmission source, Type which is a frame type, a label switched path (LSP), and a pseudo wire (PW) labels which are transfer labels.

The CES packet further includes a circuit emulation over packet (CEP) and real-time transport protocol (RTP) which are unique header areas, a payload for accommodating data of a SONET/SDH frame, and a frame check sequence (FCS) which is a detection code of a data error. The CES packet is defined in the Request for Comments (RFC) 4842 of the Internet Engineering Task Force (IETF).

The CES packet with a synchronization header is obtained by adding a synchronization header, which is used to perform the hitless switching, to the CES packet mentioned above. This synchronization header is an example of a tag and is inserted between the PW label and the CEP.

The Ethernet frame includes a DA which is a reception destination, an SA which is a transmission source, a Type which is a frame type, an LSP and PW labels which are transfer labels, a payload for accommodating client data, and an FCS which is a detection code of a data error.

The Ethernet frame with a synchronization header is obtained by adding a synchronization header, which is used to perform the hitless switching, to the earlier-mentioned Ethernet frame. This synchronization header is inserted between the PW label and the payload.

The jumbo frame is obtained by extending the maximum size of the payload of the earlier-mentioned Ethernet frame to 16000 (Byte). For example, a plurality of normal Ethernet frames is accommodated in a payload of the jumbo frame.

The jumbo frame with a synchronization header is obtained by adding a synchronization header, which is used to perform the hitless switching, to the earlier-mentioned jumbo frame. The synchronization header is inserted between the PW label and the payload.

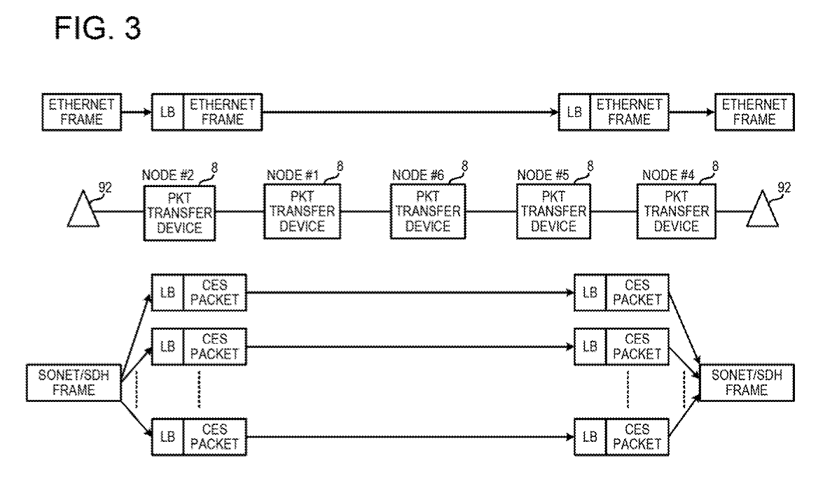

FIG. 3 illustrates an exemplary transfer of an Ethernet frame and a CES packet. In FIG. 3, a symbol LB schematically denotes a transfer label. It is assumed that the Ethernet frame and the CES packet are transferred along the paths #1 and #2 in FIG. 1. Although a route of the path #2 is illustrated in FIG. 3, the same transfer operation is applied to the path #1.

The Ethernet frame is transmitted from the network device 92 to the transfer device 8 of the node #2. The packet transfer device 8 of the node #2 adds the transfer label LB to the Ethernet frame and transfers the Ethernet frame to the packet transfer device 8 of the node #1. Each of the packet transfer devices 8 of the nodes #1, #6, and #5 transfers the Ethernet frame to the packet transfer device 8 of the node #4 according to the transfer label LB.

The packet transfer device 8 of the node #4 removes the transfer label LB from the Ethernet frame received from the node #5 and transmits the Ethernet frame to the network device 92. In this way, the Ethernet frame is transferred.

Further, the CES packet is generated from the SONET/SDH frame transmitted from the network device 92 to the packet transfer device 8 of the node #2. The packet transfer device 8 of the node #2 acquires the data in the payload from the SONET/SDH frame and divides the data in the data unit which is called a row. The packet transfer device 8 of the node #2 generates a CES packet accommodating each divided data in the payload and adds the transfer label LB to the CES packet.

For example, when the SONET/SDH frame is VC4-64C, since the data of 16704 (Byte) in the payload is divided into 8, 2088 (Bytes) (=16704÷8) per CES packet is accommodated. In addition, even when the SONET/SDH frame is in a different format such as, for example, VC4-16C, the unit of division and the number of divisions are different, but data divided into a plurality of CES packets is accommodated as described above.

The packet transfer device 8 of the node #2 transfers a plurality of CES packets to the packet transfer device 8 of the node #1. Each of the packet transfer devices 8 of the nodes #1, #6, and #5 transfers the CES packets to the packet transfer device 8 of the node #4 according to the transfer label LB.

The packet transfer device 8 of the node #4 restores the original SONET/SDH frame from the plurality of CES packets received from the packet transfer device 8 of the node #5 of the previous stage. The packet transfer device 8 of the node #4 transmits the SONET/SDH frame to the network device 92.

In this way, since the CES packet accommodates the divided data of the SONET/SDH frame, even when one packet is discarded in the packet transfer device 8, it becomes impossible to restore the SONET/SDH frame, which results in a large-scale data loss. Therefore, as will be described later, each packet transfer device 8 counts the number of discards of the CES packet and the CES packet with the synchronization header, separately from other packets, and notifies the counted number of discards to the NW management server 91. Then, the packet transfer device 8 performs an appropriate band setting according to the number of discards in cooperation with the NW management server 91 to thereby reduce the number of discards.

In the case of the CES packet with a synchronization header, since the CES packet is transferred along two redundantly configured routes in a hitless switching manner, even when the CES packet is discarded in one route, no loss of the SONET/SDH frame occurs unless the same CES packet is discarded in the other route.

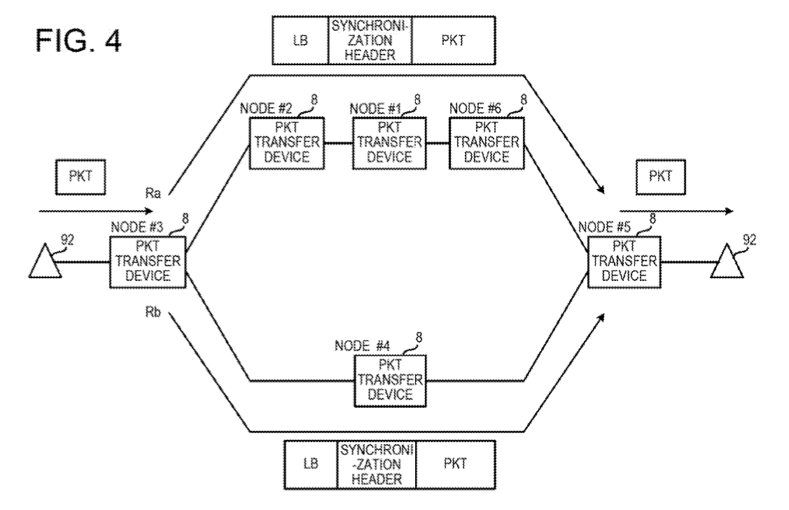

FIG. 4 illustrates an exemplary transfer of a packet with a synchronization header. The CES packet with a synchronization header, the Ethernet frame with a synchronization header, and the jumbo frame with a synchronization header, all of which are packets with a synchronization header, are transferred along the path #3 in FIG. 1. In this example, a process of simply transferring packets will be described without distinguishing between the CES packet with a synchronization header, the Ethernet frame with a synchronization header, and the jumbo frame with a synchronization header.

Upon receiving a packet (PKT) from the network device 92, the packet transfer device 8 of the node #3 adds the transfer label LB and the synchronization header to the packet and transmits the packet to each of the packet transfer devices 8 of the nodes #2 and #4. Each of the packet transfer devices 8 of the nodes #2, #1, and #6 transfers the packet to the packet transfer device 8 of the node #5 according to the transfer label LB (see a route Ra). In addition, the packet transfer device 8 of the node #4 transfers the packet to the packet transfer device 8 of the node #5 according to the transfer label LB (see a path Rb).

Since the packet transfer device 8 of the node #3 transmits the same packet to each of the packet transfer devices 8 of the nodes #2 and #4, the same packet is transferred along the two different routes Ra and Rb. Since the routes Ra and Rb are switched in the hitless switching manner, the packet transfer device 8 of the node #5 selects a packet with a good receiving condition out of the same packets respectively received from the two routes Ra and Rb and removes the transfer label LB and the synchronization header from the selected packet.

At this time, the packet transfer device 8 of the node #5 synchronizes the packets between the routes Ra and Rb based on the synchronization header. More specifically, the packet transfer device 8 of the node #5 stores the received packet in a buffer and identifies the same packet based on a hitless (un-interruption) ID in the synchronization header of the packet.

In this way, in the path #3 to which the hitless switching is applied, the packet with the synchronization header is transferred.

The packet transfer device 8 counts the number of discarded packets for each of the paths #1 to #3 and the number of discarded packets on a port basis. The packet transfer device 8 counts the number of discarded CES packets and the number of discarded CES packets with the synchronization header, while distinguishing from the number of other discarded packets. Therefore, the packet transfer device 8 determines the CES packet and the CES packet with the synchronization header based on the configuration of each packet illustrated in FIG. 2.

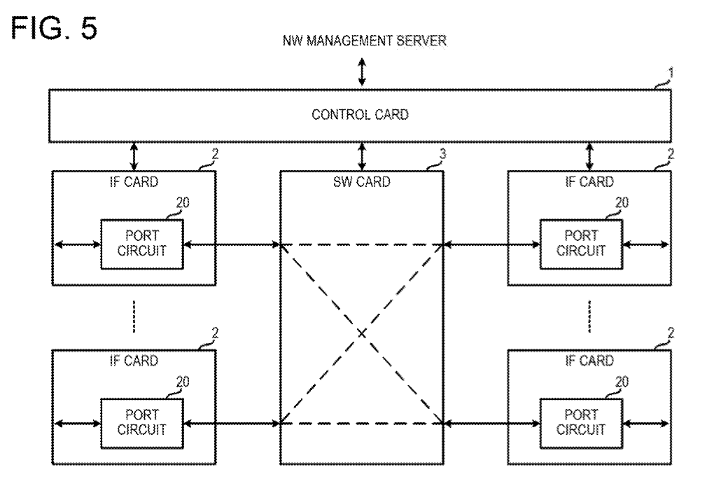

FIG. 5 is a configuration diagram illustrating an example of a packet transfer device 8. The packet transfer device 8 includes a control card 1, a plurality of interface cards (IF cards) 2, and a switch card (SW card) 3.

The control card 1, the IF cards 2, and the SW card 3 are, for example, circuit boards on which electronic components are mounted, and are accommodated in slots formed on the front face of a housing (chassis) of the packet transfer device 8. The control card 1, the IF cards 2, and the SW card 3 communicate with each other, for example, by being connected to a bus of a wiring board provided on the rear face of the housing. In addition, the control card 1, the IF cards 2, and the SW card 3 may be redundantly configured.

The IF cards 2 are connected to other packet transfer devices 8 or network devices 92 via a transmission path such as an optical fiber. The IF cards 2 transmit and receive packets to and from devices of their connection destinations.

Each of the IF cards 2 has a port circuit 20 through which a packet is input and output. The port circuit 20 performs a band control of a packet for each of the paths #1 to #3, and a band control of a packet on a port basis. Further, the port circuit 20 counts the number of packets discarded by the band control. The port circuit 20 outputs to the SW card 3 a packet received from another device and passed through without being discarded.

The SW card 3 exchanges packets with the IF cards 2. More specifically, as indicated by a dotted line, the SW card 3 outputs a packet, which is input from the port circuit 20 of an IF card 2, to the port circuit 20 of another IF card 2 corresponding to a transfer label added to the packet.

The control card 1 performs various processes such as a band control and a path setting for the IF cards 2 and the SW card 3. For example, the control card 1 performs a setting of an IF card 2 of a transfer destination corresponding to a packet transfer label for the SW card 3. Further, the control card 1 performs a path setting for the port circuit 20 of the IF card 2. The path setting includes information for identifying a packet, such as an ID of a slot of the IF card 2 in which the corresponding path is provided, an ID of the corresponding port, and an ID and a transfer label in the corresponding port.

In addition, the control card 1 acquires the number of discarded packets from the port circuit 20 and performs a band setting for each of the paths #1 to #3 and a band setting on a port basis according to the acquired number of discarded packets. At this time, the path setting and the band setting are executed under the control of the NW management server 91.

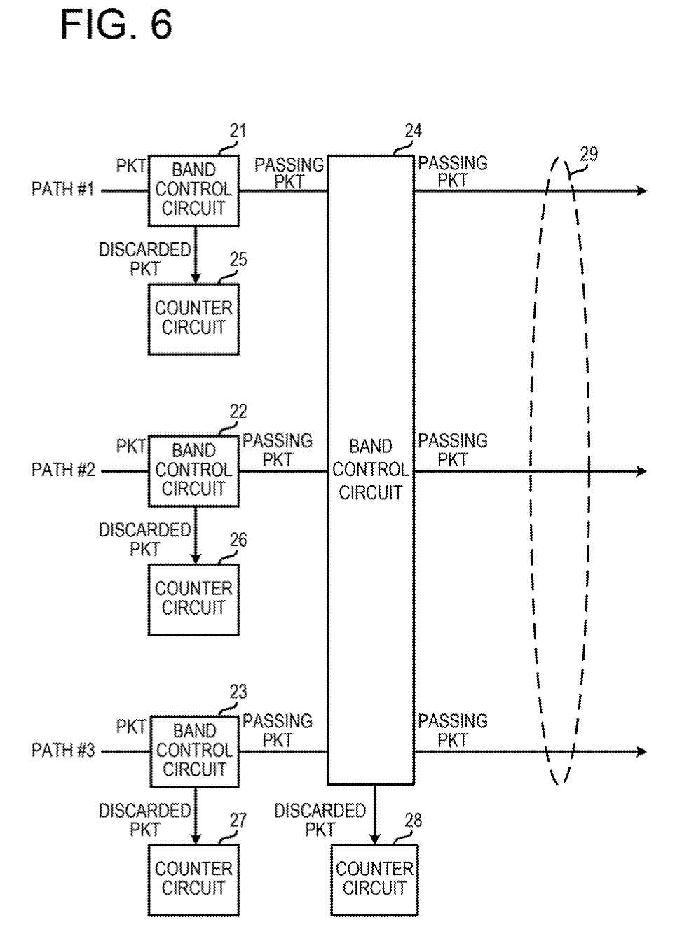

FIG. 6 is a configuration diagram illustrating an example of a port circuit 20. The port circuit 20 includes band control circuits 21 to 23 for respective paths #1 to #3, a band control circuit 24 of a port 29 accommodating the paths #1 to #3, and counter circuits 25 to 28 for counting the number of packets discarded in the band control circuits 21 to 24, respectively. An example of the band control circuits 21 to 24 may include, but is not limited to, a policer.

The band control circuit 21 performs a band control of a packet (PKT) of the path #1. The packet (passing PKT) that passed through the band control circuit 21 is input to the band control circuit 24 in the unit of port 29, and the packet (discarded PKT) discarded by the band control circuit 21 is input to the counter circuit 25. The counter circuit 25 counts the number of discarded packets of the band control circuit 21 for each type of packet.

The band control circuit 22 performs a band control of a packet (PKT) of the path #2. The packet (passing PKT) that passed through the band control circuit 22 is input to the band control circuit 24 in the unit of port 29, and the packet (discarded PKT) discarded by the band control circuit 22 is input to the counter circuit 26. The counter circuit 26 counts the number of discarded packets of the band control circuit 22 for each type of packet.

The band control circuit 23 performs a band control of a packet (PKT) of the path #3. The packet (passing PKT) that passed through the band control circuit 23 is input to the band control circuit 24 in the unit of port 29, and the packet (discarded PKT) discarded by the band control circuit 23 is input to the counter circuit 27. The counter circuit 27 counts the number of discarded packets of the band control circuit 23 for each type of packet.

The band control circuit 24 performs a band control of packets that passed through the band control circuits 21 to 23 among the packets (PKT) of the paths #1 to #3. The packet (passing PKT) that passed through the band control circuit 24 is output to the outside of the IF card 2, and the packet (discarded PKT) discarded by the band control circuit 24 is input to the counter circuit 28. The counter circuit 28 counts the number of discarded packets of the band control circuit 24 for each type of packet.

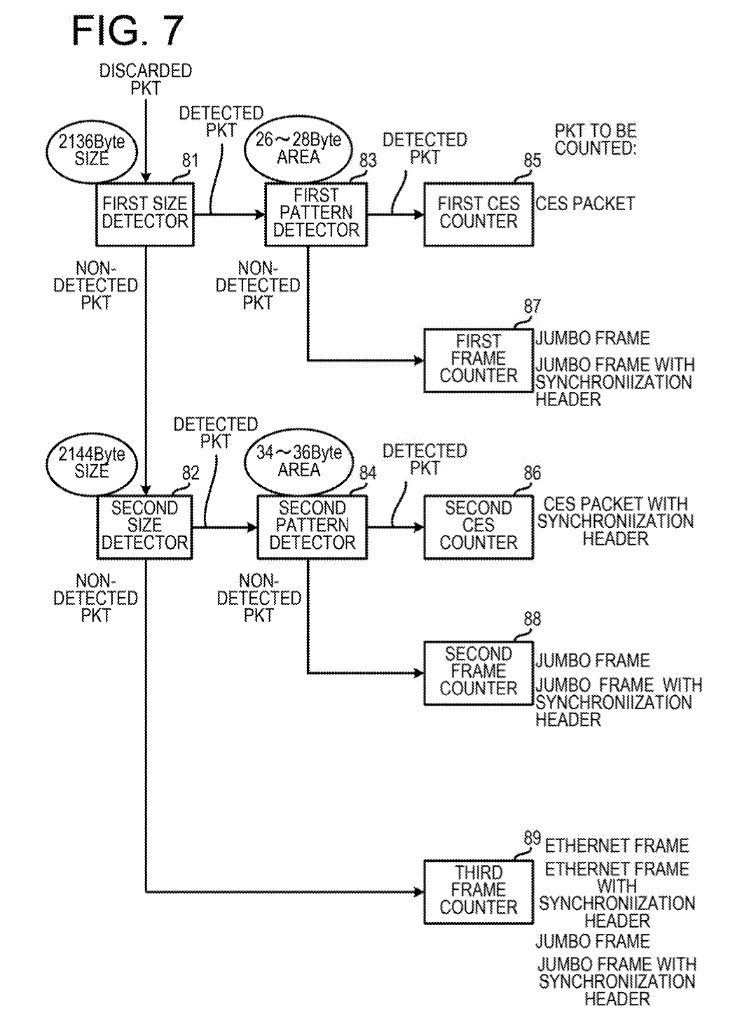

FIG. 7 is a configuration diagram illustrating an example of the counter circuits 25 to 28. Although the counter circuits 25 to 28 in this example have a common circuit configuration, the counter circuits 25 to 28 may have different configurations depending on the type of packet for each of the paths #1 to #3, as will be described later.

The counter circuits 25 to 28 each includes a first size detector 81, a second size detector 82, a first pattern detector 83, a second pattern detector 84, a first CES counter 85, a second CES counter 86, and first to third frame counters 87 to 89. In the following description, a packet detected by the first size detector 81, the second size detector 82, the first pattern detector 83, and the second pattern detector 84 is referred to as a “detected packet” (detected PKT), and a packet not detected is referred to as a “non-detected packet” (non-detected PKT). In addition, packets to be counted (“count target PKTs”) of the first CES counter 85, the second CES counter 86, and the first to third frame counter 87 to 89 are illustrated in FIG. 7.

The first size detector 81 and the second size detector 82 are an example of a size detector and detect packets of a predetermined size. More specifically, the first size detector 81 detects a packet having a size of 2136 (byte) in order to extract a CES packet from a discarded packet, and the second size detector 82 detects a packet having a size of 2144 (byte) in order to extract a CES packet with a synchronization header from a discarded packet.

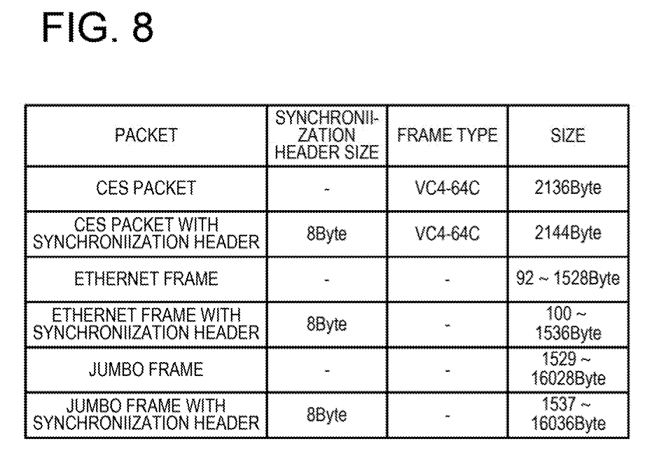

The sizes of the packets are illustrated in FIG. 8. As described above, the size of the CES packet is calculated according to the type of a SONET/SDH frame to be accommodated (see “frame type”). Therefore, the size of the CES packet is 2136 (byte) for VC4-64C. In addition, the size of the CES packet with a synchronization header is 2144 (byte) (=2136+8) when the size of the synchronization header is 8 (byte).

The size of the Ethernet frame is 92 to 1528 (byte) because its payload length is variable. In addition, the size of the Ethernet frame with a synchronization header is 100 to 1536 (byte) when the size of the synchronization header is 8 (byte).

The size of the jumbo frame is 1529 to 16028 (byte) because its payload length is variable. In addition, the size of the jumbo frame with a synchronization header is 1537 to 16036 (byte) when the size of the synchronization header is 8 (bytes).

The maximum size of the Ethernet frame is 1528 (byte), and the maximum size of the Ethernet frame with the synchronization header is 1536 (byte). Therefore, the size of each of the Ethernet frame and the Ethernet frame with the synchronization header will not match the size of the CES packet or the size of the CES packet with the synchronization header.

However, the maximum size of the jumbo frame is 16028 (byte), and the maximum size of the jumbo frame with the synchronization header is 16036 (byte). Therefore, the size of each of the jumbo frame and the jumbo frame with the synchronization header may sometimes match the size of the CES packet or the size of the CES packet with the synchronization header.

Therefore, the first size detector 81 detects the CES packet, the jumbo frame, and the jumbo frame with the synchronization header, and the second size detector 82 detects the CES frame with the synchronization header, the jumbo frame, and the jumbo frame with the synchronization header. Therefore, the counter circuits 25 to 28 are each provided with the first pattern detector 83 for detecting the CES packet by a data pattern and the second pattern detector 84 for detecting the CES packet with the synchronization header by a data pattern.

The first size detector 81 outputs the detected packet to the first pattern detector 83 and outputs the non-detected packet, that is, a packet whose size is not 2136 (byte), to the second size detector 82. The non-detected packet of the first size detector 81 includes a packet, except the CES packet, among the packets illustrated in FIG. 2.

The second size detector 82 outputs its own detected packet among the non-detected packets of the first size detector 81 to the second pattern detector 84 and outputs a packet not detected (non-detected packet), that is, a packet whose size is not 2144 (byte), to the third frame counter 89. The non-detected packet of the second size detector 82 includes all the packets, except the CES packet and the CES packet with the synchronization header, among the packets illustrated in FIG. 2. The third frame counter 89 counts the number of the non-detected packets of the second size detector 82.

The first pattern detector 83 and the second pattern detector 84 are an example of a pattern detector and each detects a packet whose data in a predetermined area matches a specific pattern, among the packets detected by the first and second size detectors 81 and 82. The first pattern detector 83 detects the CES packet by checking an area of 26 to 28 (byte) in the detected packet of the first size detector 81. The second pattern detector 84 detects the CES packet with the synchronization header by checking an area of 34 to 36 (byte) in the detected packet of the second size detector 82.

As illustrated in FIG. 2, the area of 26 to 28 (byte) of the CES packet and the area of 34 to 36 (byte) of the CES packet with the synchronization header each corresponds to a CEP area. The first pattern detector 83 and the second pattern detector 84 each may discriminate the CES packet and the CES packet with the synchronization header by identifying a specific pattern of a portion of the CEP area.

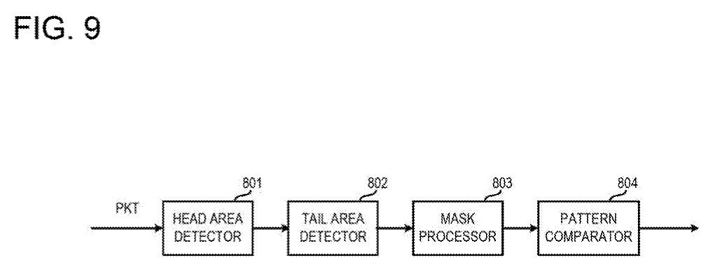

FIG. 9 is a configuration diagram illustrating an example of the first pattern detector 83 and the second pattern detector 84. The first pattern detector 83 and the second pattern detector 84 each has a head area detector 801, a tail area detector 802, a mask processor 803, and a pattern comparator 804.

The head area detector 801 detects an area of an identification target of a packet (PKT), that is, the head of the CEP area. In the case of the first pattern detector 83, the head area detector 801 detects the 26^{th} byte from the head of the packet. In the case of the second pattern detector 84, the head area detector 801 detects the 34^{th} byte from the head of the packet.

The tail area detector 802 detects the tail of the area of the identification target of the packet. In the case of the first pattern detector 83, the tail area detector 802 detects the 28^{th} byte from the head of the packet. In the case of the second pattern detector 84, the tail area detector 802 detects the 36^{th} byte from the head of the packet.

The mask processor 803 masks the area of the packet identification target to extract the area from the packet. The pattern comparator 804 compares the extracted area with a specific pattern. With this configuration, the first pattern detector 83 and the second pattern detector 84 each may discriminate the CES packet and the CES packet with the synchronization header.

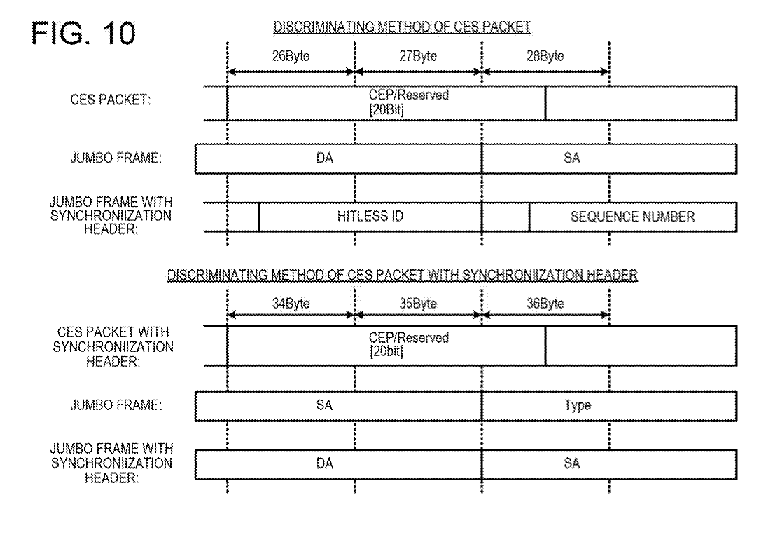

FIG. 10 illustrates a method for discriminating a CES packet and a CES packet with a synchronization header. More specifically, the first pattern detector 83 and the second pattern detector 84 identify “Reserved” areas of 20 (bit) in the CEP area. As an example, a value of “0” (binary number) is all set in the “Reserved” area.

Since the area of 26 to 28 (byte) from the head of the jumbo frame corresponds to a portion of DA and SA of the accommodated frame in the payload, it is not all “0.” In addition, since the area of 26 to 28 (byte) from the head of the jumbo frame with the synchronization header corresponds to a portion of the hitless ID and sequence numbers used in the hitless switching, it is not all “0.” Therefore, the first pattern detector 83 may discriminate that the packet is a CES packet when all the 20 (bit) data in the region of 26 to 28 (byte) are “0.”

In addition, since the area of 34 to 36 (byte) from the head of the jumbo frame corresponds to a portion of the SA and Type of the accommodated frame in the payload, it is not all “0.” In addition, since the area of 34 to 36 (byte) from the head of the jumbo frame with the synchronization header corresponds to a portion of the DA and SA of the accommodated frame in the payload, it is not all “0.” For this reason, the second pattern detector 84 may discriminate that the packet is a CES packet with a synchronization header when all the 20 (bit) data in the region of 34 to 36 (byte) are “0.”

Referring back to FIG. 7, the first pattern detector 83 outputs the CES packet, which is a detected packet, to the first CES counter 85 and outputs the jumbo frame and the jumbo frame with the synchronization header, which are non-detected packets, to the first frame counter 87. The first CES counter 85 is an example of a counter and counts the number of CES packets, and the first frame counter 87 counts the number of jumbo frames and the number of jumbo frames with a synchronization header.

The second pattern detector 84 outputs the CES packet with the synchronization header, which is a detected packet, to the second CES counter 86 and outputs the jumbo frame and the jumbo frame with the synchronization header, which are non-detected packets, to the second frame counter 88. The second CES counter 86 is another example of the counter and counts the number of CES packets with a synchronization header, and the second frame counter 88 counts the number of jumbo frames and the number of jumbo frames with a synchronization header.

In this way, the first size detector 81 and the second size detector 82 detect the CES packet and the CES packet with the synchronization header from the size of the packet, respectively. At this time, the first size detector 81 and the second size detector 82 may sometimes detect a jumbo frame and a jumbo frame with a synchronization header, both of which have the same size as the CES packet and the CES packet with the synchronization header.

However, the first pattern detector 83 and the second pattern detector 84 detect the CES packet and the CES packet with the synchronization header, respectively, from the specific pattern of the detected packet of the first size detector 81 and the second size detector 82. Therefore, the first CES counter 85 may count only the number of CES packets among a plurality of types of packets, and the second CES counter 86 may count only the number of CES packets with a synchronization header.

Each of the first size detector 81 and the second size detector 82 detects a packet of a predetermined size, and each of the first pattern detector 83 and the second pattern detector 84 identifies a pattern of a predetermined area of the packet. Therefore, the first size detector 81, the second size detector 82, the first pattern detector 83, and the second pattern detector 84 may be realized by a simple circuit without requiring a complicated processing.

Therefore, the packet transfer device 8 may count the CES packet and the CES packet with the synchronization header with a small-scale configuration.

Each of the first CES counter 85, the second CES counter 86, and the first to third frame counters 87 to 89 notifies the control card 1 of a counter value, for example, at regular intervals. Therefore, based on the notified counter value, the control card 1 performs an appropriate band setting for each of the band control circuits 21 to 24 in cooperation with the NW management server 91, thereby reducing the number of discarded CES packets and discarded CES packets with the synchronization header.

In addition, by summing the respective counter values of the first to third frame counters 87 to 89 and performing an appropriate band setting based on a total value, the control card 1 may reduce the number of discarded Ethernet frames, discarded jumbo frames, discarded Ethernet frames with a synchronization header, and discarded jumbo frames with a synchronization header. In this manner, the packet transfer device 8 of the embodiment may eventually improve the communication quality of the network 90.

Further, the control card 1 may set the size of the detected packet for the first size detector 81 and the second size detector 82 and may set a data area of the specific pattern of the detected packet (that is, 26 to 28 (byte) and 34 to 36 (byte)) for the first pattern detector 83 and the second pattern detector 84. Furthermore, as will be described below, the control card 1 may configure and set the counter circuits 25 to 28 according to information for each of the paths #1 to #3.

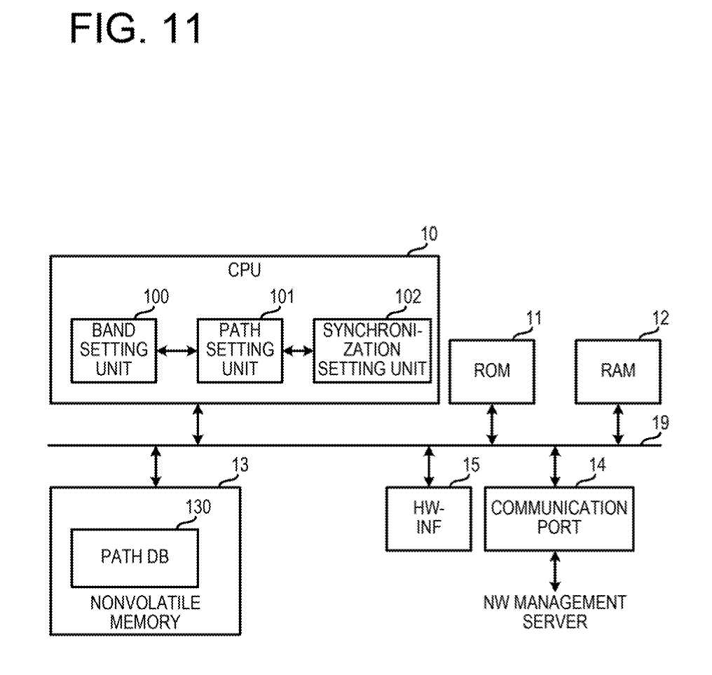

FIG. 11 is a configuration diagram illustrating an example of the control card 1. The control card 1 includes a central processing unit (CPU) 10, a read only memory (ROM) 11, a random access memory (RAM) 12, a nonvolatile memory 13, a communication port 14, and a hardware interface (HW-INF) 15. The CPU 10 is connected to the ROM 11, the RAM 12, the nonvolatile memory 13, the communication port 14, and the HW-INF 15 via a bus 19 so that signals may be inputted and outputted therebetween.

The ROM 11 stores a program for driving the CPU 10. At least a part of the program in the ROM executes a counter setting method for setting the counter circuits 25 to 28 as a counter setting program.

The RAM 12 functions as a working memory of the CPU 10. The communication port 14 is, for example, a network interface card (NIC) and processes a communication with the NW management server 91. The HW-INF 15 is, for example, a bus controller and processes a communication with each IF card 2 and the SW card 3.

The CPU 10 is an example of a computer. When the program is read from the ROM 11, a band setting unit 100, a path setting unit 101, and a circuit setting unit 102 are formed as functions of the CPU 10. A path database (path DB) 130, which is an example of path information on the paths #1 to #3 to which packets are transferred, is stored in the nonvolatile memory 13. Here, the nonvolatile memory 13 is an example of a storage unit.

The band setting unit 100 collects counter values of the respective counter circuits 25 to 28, for example, periodically and communicates with the NW management server 91 via the communication port 14 so as to set band values of passing packets to the respective band control circuits 21 to 24. As a result, the number of discarded packets in each of the band control circuits 21 to 24 is reduced.

The path setting unit 101 sets a path to each IF card 2 and the SW card 3 based on the path DB 130. Further, the path setting unit 101 notifies the band setting unit 100 and the circuit setting unit 102 of the completion of the path setting.

The circuit setting unit 102 performs configuration and parameter setting of the counter circuits 25 to 28 based on the path DB 130. The circuit setting unit 102, which is an example of a setting unit, sets the sizes of detected packets of the first size detector 81 and the second size detector 82 based on the path DB 130 and sets a position of data area of the specific pattern of detected packets of the first pattern detector 83 and the second pattern detector 84. Therefore, an appropriate size according to the corresponding path is set in the first size detector 81 and the second size detector 82, and an appropriate position of the “Reserved” area according to the corresponding path is set in the first pattern detector 83 and the second pattern detector 84.

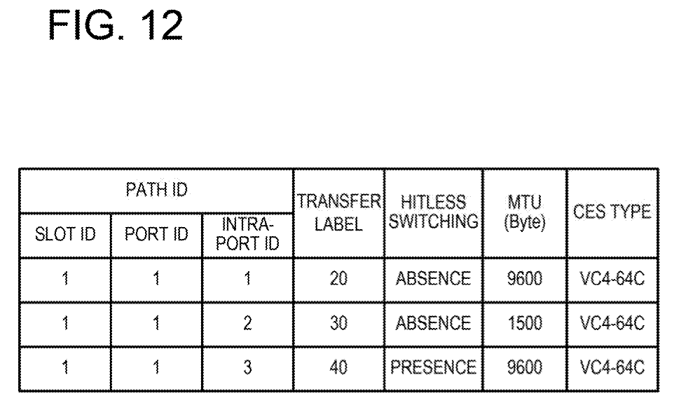

FIG. 12 illustrates an example of the path DB 130. A path ID which is an identifier of a path, a transfer label value of the path, the presence or absence of hitless switching, the maximum transmission unit (MTU) value, and the type of a SDH/SONET frame accommodated in a CES packet (referred to as a “CES type”) are registered with the path DB 130.

The path ID includes a slot ID of an IF card 2 accommodating a path, a port ID which is an identifier of the port 29, and an intra-port ID which is an identifier in the port. In the following description, it is assumed that the slot ID=“1,” the port ID=“1,” and the intra-port ID=“1” correspond to the above-mentioned path #1, the slot ID=“1,” the port ID=“1,” and the intra-port ID=“2” correspond to the above-mentioned path #2, and the slot ID=“1,” the port ID=“1,” and the intra-port ID=“3” correspond to the above-mentioned path #3.

The transfer label indicates a transfer destination of the packet of the path. In addition, a synchronization header is added to a packet of a path with hitless switching of “Presence,” and no synchronization header is added to a packet of a path with hitless switching of “Absence.” In this example, since only the path #3 among the paths #1 to #3 corresponds to the hitless switching, the synchronization header is added to the packet of the path #3. That is, the information on the presence/absence of hitless switching in the path DB 130 indicates the presence/absence of addition of the synchronization header to the packet for each of the paths #1 to #3.

In addition, the MTU indicates the prescribed maximum size of the Ethernet of the packet of the path. In this example, the MTUs of the paths #1 and #3 are 9600 (byte). Therefore, not only the Ethernet frame but also the jumbo frame can be transmitted to the path #1 and not only the Ethernet frame with the synchronization header but also the jumbo frame with the synchronization header can be transmitted to the path #3. That is, the MTU indicates the presence or absence of transmission of the jumbo frame and the jumbo frame with the synchronization header for each of the paths #1 to #3.

The circuit setting unit 102 constitutes each of the counter circuits 25 to 28 based on information on the presence/absence of hitless switching in the path DB, the MTU, and the CES type and sets the sizes of packets to be checked in each of the counter circuits 25 to 28 and the position of the “Reserved” area.

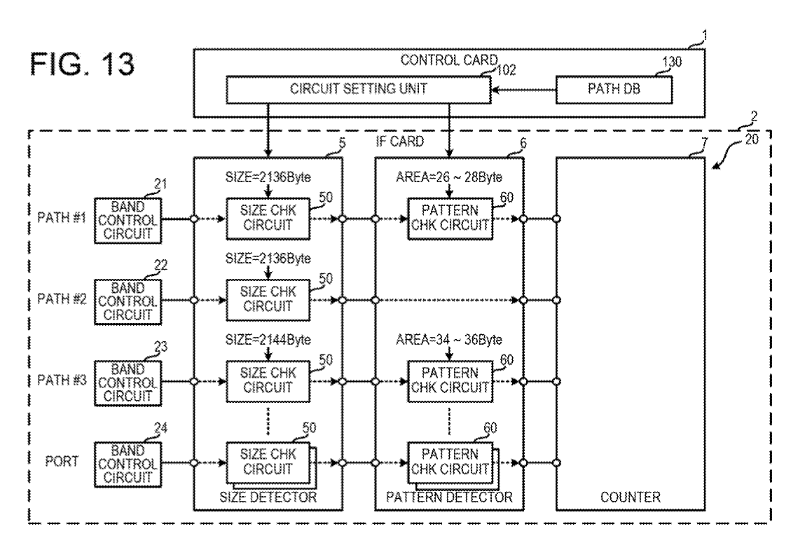

FIG. 13 illustrates an example of a setting process of each of the counter circuits 25 to 28. The port circuit 20 includes band control circuits 21 to 24, a size detector 5 in which a plurality of size check circuits (size CHK circuits) 50 are formed, a pattern detector 6 in which a plurality of pattern check circuits (pattern CHK circuits) 60 is formed, and a counter 7. Each of the size CHK circuits 50 corresponds to the first size detector 81 and the second size detector 82 and each of the pattern CHK circuits 60 corresponds to the first pattern detector 83 and the second pattern detector 84. The counter 7 includes the counters 85 to 89 illustrated in FIG. 7.

The circuit setting unit 102 specifies the type of packet for each of the paths #1 to #3 based on the information of the path DB 130. The circuit setting unit 102 selects a size CHK circuit 50 and a pattern CHK circuit 60, which are required at minimum for detecting a CES packet or a CES packet with a synchronization header according to the packet type of each of the paths #1 to #3, and connects the selected circuits to the corresponding band control circuit 21 to 24. At this time, the circuit setting unit 102 sets a size of a check target in the selected size CHK circuit 50 and sets an area of the check target (that is, a position of the area in the packet) in the selected pattern CHK circuit 60.

When configuring the counter circuit 25 of the path #1, by referring to the path DB 130, the circuit setting unit 102 determines from the information on the presence/absence of hitless switching that a packet with a synchronization header is not transmitted to the path #1 but determines from the CES type that a CES packet of 2136 (byte) is transmitted to the path #1. Therefore, the circuit setting unit 102 selects an unused size CHK circuit 50 and sets a size of a check target of the selected size CHK circuit 50 to 2136 (byte). The circuit setting unit 102 connects the selected size CHK circuit 50, as the first size detector 81, to the band control circuit 21 of the path #1 and the third frame counter 89 in the counter 7 (see a dotted arrow).

In addition, by referring to the path DB 130, the circuit setting unit 102 determines from the MTU that a jumbo frame is transmitted to the path #1. Therefore, the circuit setting unit 102 selects an unused pattern CHK circuit 60 and sets an area of a check target of the selected pattern CHK circuit 60 to 26 to 28 (byte). The circuit setting unit 102 connects the selected pattern CHK circuit 60, as the first pattern detector 83, to the first size detector 81 of the path #1 and the first CES counter 85 and the first frame counter 87 in the counter 7 (see a dotted arrow).

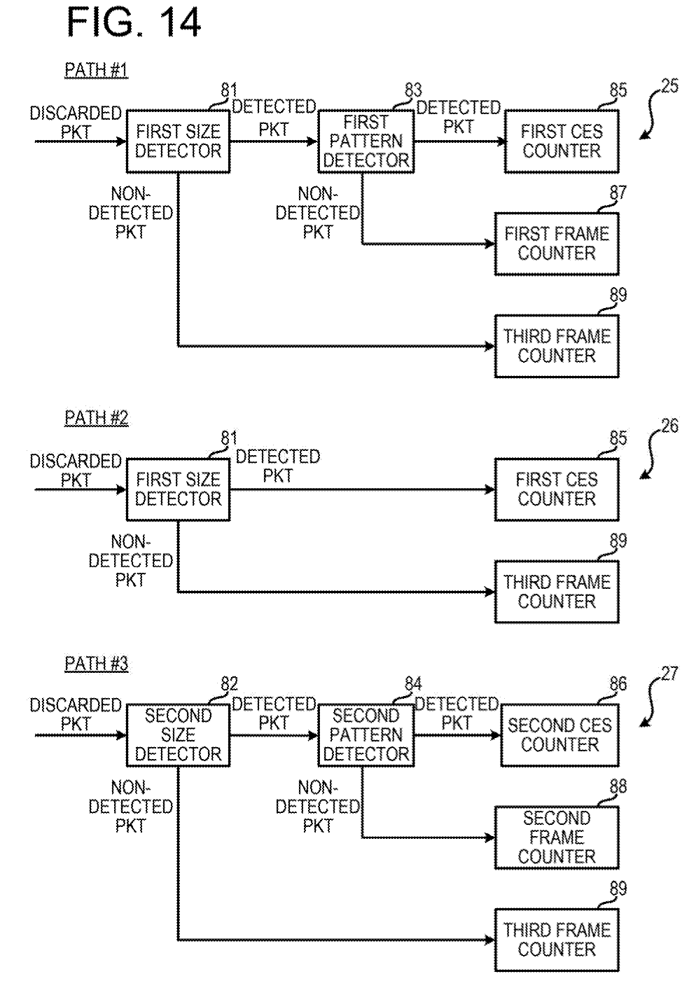

FIG. 14 is a configuration diagram illustrating an example of the counter circuits 25 to 27 for the respective paths #1 to #3. In FIG. 14, the same configurations as FIG. 7 will be denoted by the same reference numerals as used in FIG. 7, and explanation thereof will be omitted.

The counter circuit 25 of the path #1 is configured by connection processing of the circuit setting unit 102 and includes the first size detector 81, the first pattern detector 83, the first CES counter 85, the first frame counter 87, and the third frame counter 89.

The first size detector 81 detects a jumbo frame or a CES packet of 2136 (byte). The first size detector 81 outputs the detected packet to the first pattern detector 83 and outputs a non-detected packet to the third frame counter 89.

The first pattern detector 83 detects a packet whose region of 26 to 28 (byte) matches a specific pattern, that is, a CES packet whose “Reserved” area is all “0.” The first pattern detector 83 outputs the detected packet to the first CES counter 85 and outputs a non-detected packet to the first frame counter 87.

With the above configuration, the counter circuit 25 of the path #1 may realize the same counting function as FIG. 7 while being smaller than that illustrated in FIG. 7.

Referring back to FIG. 13, when configuring the counter circuit 25 of the path #2, by referring to the path DB 130, the circuit setting unit 102 determines from the information on the presence/absence of hitless switching that a packet with a synchronization header is not transmitted to the path #2. Further, the circuit setting unit 102 determines from the MTU that a jumbo frame and a jumbo frame with a synchronization header is not transmitted to the path #2 but determines from the CES type that a CES packet of 2136 (byte) is transmitted to the path #2.

Therefore, the circuit setting unit 102 selects an unused size CHK circuit 50 and sets a size of a check target of the selected size CHK circuit 50 to 2136 (byte). The circuit setting unit 102 connects the selected size CHK circuit 50, as the first size detector 81, to the band control circuit 22 of the path #2 and the first CES counter 85 and the third frame counter 89 in the counter 7 (see a dotted arrow).

Further, since the jumbo frame and the jumbo frame with the synchronization header are not transmitted to the path #2, the circuit setting unit 102 does not need to identify a specific pattern of the “Reserved” area of the CES packet. Therefore, the pattern setting unit 102 does not use the pattern CHK circuit 60. In other words, since there is no other packet of the same size as the CES packet, the first pattern detector 83 becomes unnecessary.

Referring back to FIG. 14, the counter circuit 26 of the path #2 is configured by connection processing of the circuit setting unit 102 and includes the first size detector 81, the first CES counter 85, and the third frame counter 89. The first size detector 81 detects a CES packet of 2136 (Byte). The first size detector 81 outputs the detected packet to the first CES counter 85 and outputs a non-detected packet to the third frame counter 89.

With the above configuration, the counter circuit 26 of the path #2 may realize the same counting function as FIG. 7 while being smaller than that shown in FIG. 7.

Referring back to FIG. 13, when configuring the counter circuit 27 of the path #3, by referring to the path DB 130, the circuit setting unit 102 determines from the information on the presence/absence of hitless switching that a packet with a synchronization header is transmitted to the path #3 and determines from the CES type that a CES packet with a synchronization header of 2144 (byte) is transmitted to the path #3. Therefore, the circuit setting unit 102 selects an unused size CHK circuit 50 and sets a size of a check target of the selected CHK circuit 50 to 2144 (byte). The circuit setting unit 102 connects the selected size CHK circuit 50, as the second size detector 82, to the band control circuit 23 of the path #3 and the third frame counter 89 in the counter 7 (see a dotted arrow).

In addition, by referring to the path DB 130, the circuit setting unit 102 determines from the MTU that a jumbo frame with a synchronization header is transmitted to the path #3. Therefore, the circuit setting unit 102 selects an unused pattern CHK circuit 60 and sets an area of a check target of the selected pattern CHK circuit 60 to 34 to 36 (byte). The circuit setting unit 102 connects the selected pattern CHK circuit 60, as the second pattern detector 84, to the second size detector 82 of the path #3 and the second CES counter 86, the second frame counter 88 and the third frame counter 89 in the counter 7 (see a dotted arrow).

Referring back to FIG. 14, the counter circuit 27 of the path #3 is constituted by connection processing of the circuit setting unit 102 and includes the second size detector 82, the second pattern detector 84, the second CES counter 86, the second frame counter 88, and the third frame counter 89.

The second size detector 82 detects a jumbo frame with a synchronization header of 2144 (byte) or a CES packet with a synchronization header of 2144 (byte). The second size detector 82 outputs the detected packet to the second pattern detector 84 and outputs a non-detected packet to the third frame counter 89.

The second pattern detector 84 detects a packet whose region of 34 to 36 (byte) matches a specific pattern, that is, a CES packet with a synchronization header whose “Reserved” area is all “0.” The second pattern detector 84 outputs the detected packet to the second CES counter 86 and outputs a non-detected packet to the second frame counter 88.

With the above configuration, the counter circuit 27 of the path #3 may realize the same counting function as FIG. 7 while being smaller than that shown in FIG. 7.

In this way, the circuit setting unit 102 sets a size of a detected packet of the first size detector 81 and the second size detector 82 and a position of an area of a detected packet of the first pattern detector 83 and the second pattern detector 84 according to the paths #1 to #3 to which a packet is transferred, based on the information on the presence/absence of hitless switching. Therefore, depending on the presence or absence of a synchronization header of a packet for each of the paths #1 to #3, the counter circuits 25 to 27 may count the number of discarded CES packets or the number of discarded CES packets with a synchronization header, separately from other packets.

In addition, when configuring the counter circuit 28 of the port 29, since all types of packets are transferred to the port 29, the circuit setting unit 102 constitutes a counter circuit 28 similar to that illustrated in FIG. 7.

Next, a flow of a method for setting the counter circuits 25 to 27 will be described.

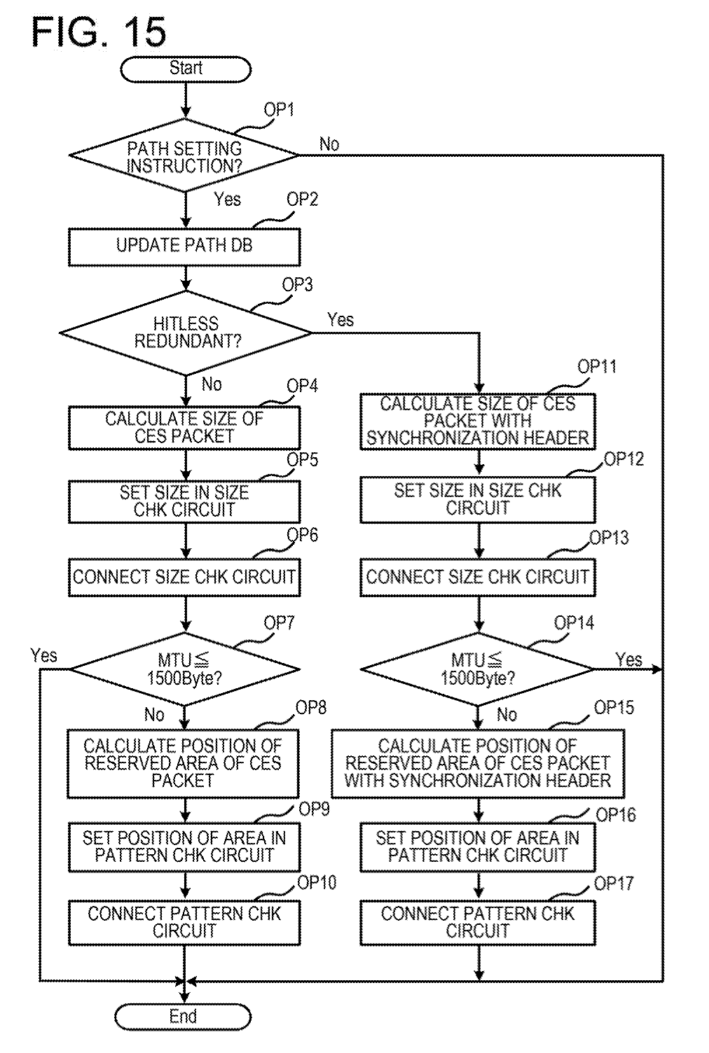

FIG. 15 is a flowchart illustrating an example of a method for setting the counter circuits 25 to 27. The circuit setting unit 102 checks the presence or absence of a path setting instruction from the NW management server 91 for the communication port 14 (Operation OP1). When it is determined that there is no path setting instruction (No in Operation OP1), the circuit setting unit 102 ends the process.

When it is determined that there is a path setting instruction (Yes in Operation OP1), the circuit setting unit 102 updates the path DB 130 based on the contents of the instruction (Operation OP2). Next, the circuit setting unit 102 determines the presence/absence of hitless switching for a setting target path by referring to the path DB 130 (Operation OP3).

When it is determined that there is no hitless switching in the setting target path (No in Operation OP3), the circuit setting unit 102 executes processing after Operation OP4. When it is determined that there is hitless switching in the setting target path (Yes in Operation OP3), processing after Operation OP11 is executed. Therefore, in the above example, when setting the paths #1 and #2, the processing after Operation OP4 is executed, and, when setting the path #3, the processing after Operation OP11 is executed.

When it is determined that there is no hitless switching in the setting target path (No in Operation OP3), the circuit setting unit 102 calculates a size (2136 (byte)) of a CES packet based on the CES type of the path DB 130 (Operation OP4). Next, the circuit setting unit 102 selects a size CHK circuit 50 and sets the calculated size in the selected size CHK circuit 50 (Operation OP5).

That is, the circuit setting unit 102 sets a size of a CES packet to be detected, in the first size detector 81. Next, the circuit setting unit 102 connects the size CHK circuit 50 to the band control circuits 21 and 22 and the counter 7 (Operation OP6).

Next, by referring to the MTU of the path DB 130, the circuit setting unit 102 determines whether or not the MTU is 1500 (bytes) or less (Operation OP7). When it is determined that the MTU is larger than 1500 (byte) (No in Operation OP7), the circuit setting unit 102 calculates a position (26 to 28 (byte)) of the “Reserved” area of the CES packet (Operation OP8). In this case, a setting target path is the path #1.

Next, the circuit setting unit 102 selects a pattern CHK circuit 60 and sets the calculated position of the “Reserved” area in the selected pattern CHK circuit 60 (Operation OP9). That is, the circuit setting unit 102 sets a position of the “Reserved” area of a specific pattern included in the CES packet to be detected, for the first pattern detector 83. This makes it possible to distinguish a CES packet and a jumbo frame of the same size from each other. Next, the circuit setting unit 102 connects the pattern CHK circuit 60 to the band control circuit 21 and the counter 7 (Operation OP10).

Further, when it is determined that the MTU is 1500 (byte) or less (Yes in Operation OP7), the circuit setting unit 102 ends the process. In this case, since a jumbo frame is not transmitted to a path to be set, the circuit setting unit 102 does not need to distinguish the CES packet from the jumbo frame. Therefore, it is unnecessary to use the pattern CHK circuit 60. In this case, the setting target path is path #2.

When it is determined that there is hitless switching in the setting target path (Yes in Operation OP3), the circuit setting unit 102 calculates a size (2144 (byte)) of a CES packet with a synchronization header based on the CES type of the path DB 130 (Operation OP11). Next, the circuit setting unit 102 selects a size CHK circuit 50 and sets the calculated size in the selected size CHK circuit 50 (Operation OP12).

That is, the circuit setting unit 102 sets a size of the CES packet with the synchronization header to be detected, in the second size detector 82. Next, the circuit setting unit 102 connects the selected size CHK circuit 50 to the band control circuit 23 and the counter 7 (Operation OP13).

Next, by referring to the MTU of the path DB 130, the circuit setting unit 102 determines whether or not the MTU is 1500 (byte) or less (Operation OP14). When it is determined that the MTU is larger than 1500 (byte) (No in Operation OP14), the circuit setting unit 102 calculates a position (34 to 36 (byte)) of the “Reserved” area of the CES packet (Operation OP15).

Next, the circuit setting unit 102 selects a pattern CHK circuit 60 and sets the calculated position of the “Reserved” area in the selected pattern CHK circuit 60 (Operation OP16). That is, the circuit setting unit 102 sets a position of the “Reserved” area of a specific pattern included in the CES packet with the synchronization header to be detected, in the second pattern detector 84. This makes it possible to distinguish a CES packet with a synchronization header and a jumbo frame with a synchronization header of the same size from each other. Next, the circuit setting unit 102 connects the selected pattern CHK circuit 60 to the band control circuit 23 and the counter 7 (Operation OP17). In this manner, the method for setting the counter circuits 25 to 27 is executed.

Further, when it is determined that the MTU is 1500 (byte) or less (Yes in Operation OP14), the circuit setting unit 102 ends the process. In this case, since the jumbo frame with the synchronization header is not transferred to a path to be set, the circuit setting unit 102 does not need to distinguish the CES packet with the synchronization header from the jumbo frame with the synchronization header. Therefore, it is unnecessary to use the pattern CHK circuit 60.

As described above, the circuit setting unit 102 sets a size of a packet to be detected, in the first size detector 81 and the second size detector 82 according to the path DB 130 related to the paths #1 to #3 for transferring packets. Further, the circuit setting unit 102 sets the position of the data area of a specific pattern included in the packet to be detected, in the first pattern detector 83 and the second pattern detector 84 according to the path DB 130.

Therefore, an appropriate size according to the corresponding path is set in the first size detector 81 and the second size detector 82, and an appropriate position of the “Reserved” area corresponding to the corresponding path is set in the first pattern detector 83 and the second pattern detector 84.

The above-described processing function may be realized by a computer. In that case, a program describing processing contents of functions to be possessed by a processor is provided. By executing the program with the computer, the processing function is realized on the computer. The program describing the processing contents may be recorded in a computer-readable recording medium (excluding a carrier wave).

When distributing a program, it is sold in the form of a portable recording medium such as, for example, a digital versatile disc (DVD) and a compact disc read only memory (CD-ROM), in which the program is recorded. Further, the program may be stored in a storage device of a server computer and transferred from the server computer to another computer via a network.

The computer executing the program stores the program recorded in the portable recording medium or the program transferred from the server computer in its own storage device. Then, the computer reads the program from its own storage device and executes processing according to the program. The computer may read the program directly from the portable recording medium and execute processing according to the program. Further, each time the program is transferred from the server computer, the computer may sequentially execute processing according to the received program.

While descriptions have made for the embodiments described above, the present disclosure is not limited thereto, but various modifications may be made without departing from the spirit and scope of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A packet transfer device comprising:
a memory; and
a processor coupled to the memory and the processor configured to:
detect a first packet of a predetermined size,
detect a second packet whose data in a predetermined area matches a specific pattern, the second packet being included in a group of the first packet, and
count a number of the second packet.

2. The packet transfer device according to claim 1,
wherein path information of a path on which a packet is transferred is stored in the memory; and
wherein the processor sets a size of the first packet to be detected and a position of the area of the specific pattern included in the second packet to be detected, based on the path information.

3. The packet transfer device according to claim 2,
wherein the path information indicates a presence or an absence of a predetermined tag added to the packet transferred on the path.

4. A method for setting a counter, the method comprising:
setting, to a size detector, a size of a first packet to be detected by the size detector, based on path information of a path on which a packet is transferred; and
setting, to a pattern detector, a position of a data area of a specific pattern included in a second packet to be detected by the pattern detector, based on the path information, the second packet being included in a plurality of first packets detected by the size detector, by a processor.

5. The method according to claim 4, further comprising:
detecting the first packet of a predetermined size;
detecting the second packet whose data in a predetermined area matches a specific pattern; and
counting a number of the second packet, by the processor.

6. The method according to claim 5,
wherein the path information indicates a presence or an absence of a predetermined tag added to the packet transferred on the path.

7. A computer-readable non-transitory recording medium storing a program that causes a computer to execute a procedure, the procedure comprising:
setting, to a size detector, a size of a first packet to be detected by the size detector, based on path information of a path on which a packet is transferred; and
setting, to a pattern detector, a position of a data area of a specific pattern included in a second packet to be detected by the pattern detector, based on the path information, the second packet being included in a plurality of first packets detected by the size detector.

8. The computer-readable non-transitory recording medium according to claim 7, wherein the procedure further comprising:
detecting the second packet whose data in a predetermined area matches a specific pattern; and
counting a number of the second packet.

9. The computer-readable non-transitory recording medium according to claim 8,
wherein the path information indicates a presence or an absence of a predetermined tag added to the packet transferred on the path.
